(19) United States
(12) Patent Application Publication
(10) Pub. No.: US 2012/0230728 A1
(43) Pub. Date: Sep. 13, 2012

(54) APPARATUS FOR MOUNTING A PHOTOCONDUCTOR

(76) Inventors: Jeffrey A. Pitas, Macedon, NY (US); Richard G. Luther, Hamlin, NY (US)

(21) Appl. No.: 13/041,687

(22) Filed: Mar. 7, 2011

(51) Int. Cl. G03G 15/00

(52) U.S. Cl. 399/117

(57) ABSTRACT

An apparatus for mounting a cylindrical photoreceptor (206) includes a gudgeon (241) attached to a photoconductor; a stationary mount (242) attached to the photoconductor ; and wherein a diameter of the stationary mount matches a diameter of the photoconductor.

### CROSS REFERENCE TO RELATED APPLICATIONS

Reference is made to commonly-assigned copending U.S. patent application Ser. No. ______ (Attorney Docket No. 96606/NAB), filed herewith, entitled METHOD FOR MOUNTING A PHOTOCONDUCTOR, by Pitas et al.; the disclosure of which is incorporated herein.

### FIELD OF THE INVENTION

The invention relates to electrophotography in general and in particular to an apparatus for mounting a photoconductor in an electrophotographic apparatus.

### BACKGROUND OF THE INVENTION

The electrophotographic process is used as a means of creating an image on paper or other suitable printing media. The electrophotographic process uses various components assembled into a print engine to enable printing. In order for those components to function correctly they must be mounted within the printer precisely and rigidly. The more precisely the components are mounted, the less correction is necessary for an accurate, well focused image placement on paper. Some components need to be replaced as part of normal operations. During this process, they must be positioned in a proper functional orientation. There is, therefore, a need to accurately locate components relative to a photoreceptive cartridge in a manner which minimizes necessary image registration correction. There is also a need for the process to be repeatable, and which minimizes variation when assemblies are interchanged.

### SUMMARY OF THE INVENTION

Briefly, according to one aspect of the present invention an apparatus for mounting a cylindrical photoreceptor includes a gudgeon attached to a photoconductor; a stationary mount attached to the photoconductor; and wherein a diameter of the stationary mount matches a diameter of the photoconductor.

The invention and its objects and advantages will become more apparent in the detailed description of the preferred embodiment presented below.

### BRIEF DESCRIPTION OF THE DRAWINGS

FIG. 1 is a cross-section of a replacement cartridge according to the present invention.

FIG. 2 is a cross-section of a replacement cartridge in an electrophotographic printer.

FIG. 3 is a perspective view of a replacement cartridge being assembled to a framework.

FIG. 4 is a detailed view of one end of a photoreceptor member.

FIG. 5 is a detailed view of an alternate construction of one end of a photoreceptor member.

FIG. 6 is a detailed view of an alternate construction of one end of a photoreceptor member.

FIG. 7 is a detailed view of an alternate construction of one end of a photoreceptor member.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

An electrophotographic printer includes components necessary to print an image on paper. The printer is comprised of various sub-assemblies which perform specific functions.

An imaging module in the printer consists of components to print a single color image. Multiple imaging modules may be assembled to enable the printing of multiple color images. FIG. 1 shows details of a typical printing module 31, which may be assembled with other imaging modules to enable printing multiple colors.

Primary charging subsystem 210 uniformly electrostatically charges photoreceptor 206 of photoreceptive member 111, shown in the form of an imaging cylinder. Charging subsystem 210 may include a grid 213 having a selected voltage, or may be in the form of a roller with conductive properties.

Additional necessary components provided for control may be assembled around the various process elements of the respective printing modules. Meter 211 measures the uniform electrostatic charge provided by charging subsystem 210, and meter 212 measures the post-exposure surface potential within a patch area of a latent image formed from time to time in a non-image area on photoreceptor 206.

Image writer 220 is used to expose photoreceptor 206 and may be a light emitting diode (LED) array or other similar mechanisms. Toning unit 225, comprising elements 226 and 227 is used to develop the latent image created by image writer 220 on photoreceptor 206. Cleaning unit 230 removes residual toner from photoreceptor 206 after transfer of the image to a secondary receiver. Other meters and components may be included.

Within the printing module 31, periodic replacement of critical components is necessary to ensure proper function. It may be desired to cluster multiple components to enable simultaneous replacement.

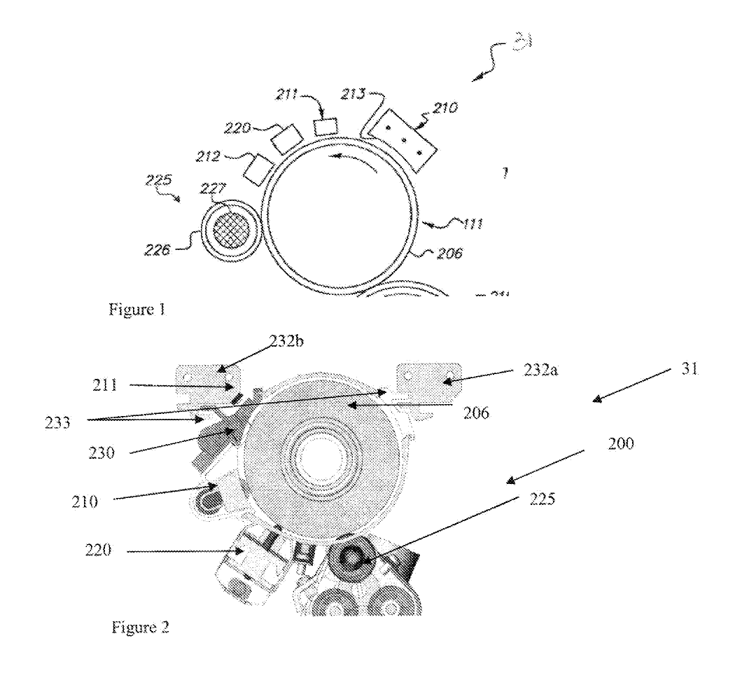

Referring to FIG. 2, a replacement cartridge 200 consists of a photoreceptive member 111, cleaning unit 230, and charging subsystem 210. These components are assembled into a cartridge and held in place with a plastic housing 233. The replacement cartridge slides into the electrophotographic printer with guides 232a, 232b. Guides 232a and 232b are attached to the printer and help mount and align the replacement cartridge in the proper position.

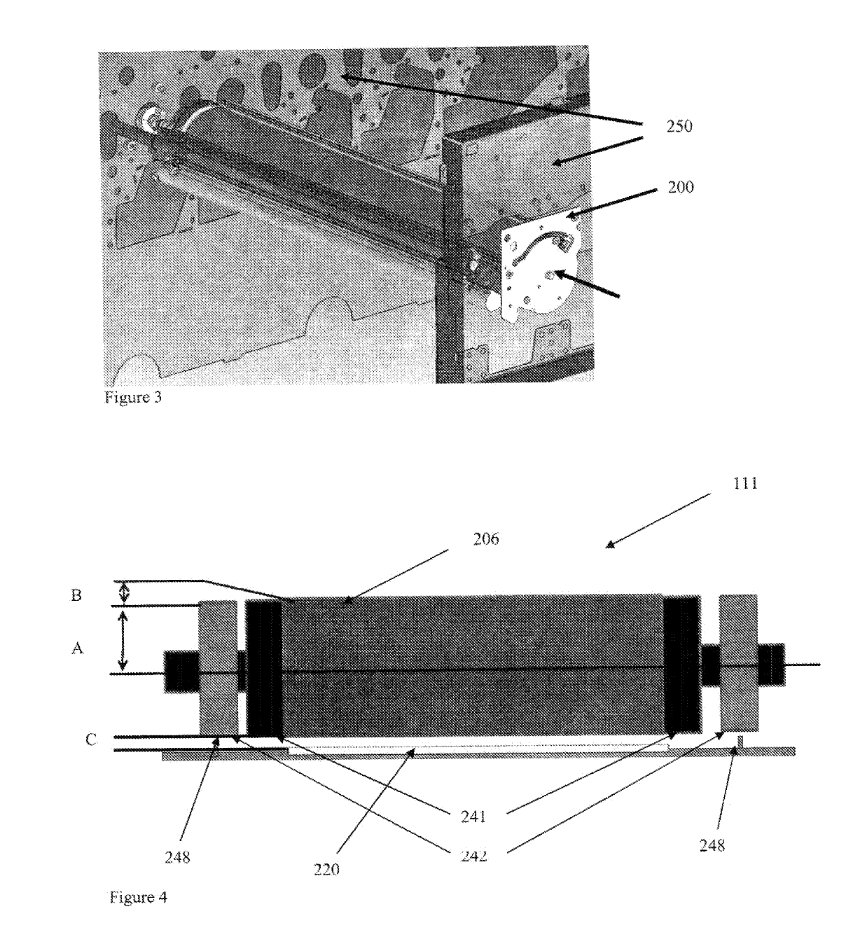

Referring now to FIG. 3 the replacement cartridge is shown oriented to a framework 250 of the printer. The framework 250 is designed to accommodate many subsystems which all depend on the precision of framework features for proper alignment. Within the framework are components that align to the replacement cartridge 200, whose spacing to the photoreceptor 206 is critical.

Referring now to FIG. 4 a photoreceptive member 111 is shown consisting of photoreceptor 206 and gudgeon 241. The photoreceptor may be a coated rigid tube or may be a rigid tube with a photoreceptor sleeve affixed. The photoreceptive member 111 rotates having gudgeon 241 turning in stationary mount 242. The stationary mount is fixed to the plastic housing 233 shown in FIG. 2.

The stationary mount 242 is made with a precisely controlled inner and outer diameter. Suitable materials are chosen to enable low torque and long bearing surface life. The gudgeon 241 has precisely controlled bearing surface and outer diameter. The photoreceptor has precisely controlled inner diameter, which the gudgeon 241 presses into, and precisely controlled outer diameter. The construction is designed to provide precise spacing “B” between the outside of the stationary mount 242 and the photoreceptor 206. If materials with similar thermal expansion characteristics are chosen the spacing change is minimal with temperature change.

An image writer 220 is maintained at a certain distance from the photoreceptor 206 with critical spacing feature 248. The spacing feature 248 is precisely located to the image writer 220, such that the overall spacing C between the writer and photoreceptor 206 is precisely controlled. A similar approach can be used for the toning unit 225, cleaning unit 230, charging subsystem 210 and other features requiring precise location. The means of accurate, well controlled spacing between the photoreceptor surface and electrophotographic elements ensure a well focused image and proper function of the electrophotographic printer.

Because many of the subsystems are not part of the replacement cartridge 200, it is necessary to retract them from engagement with the stationary mount 242 prior to replacing the cartridge. It is convenient to make the outer diameter of the stationary mount similar in diameter to the photoreceptor to limit the refraction distance needed for clearance to spacing feature 248. For some systems this may not be a factor so a more appropriate diameter according to the particular design may be chosen.

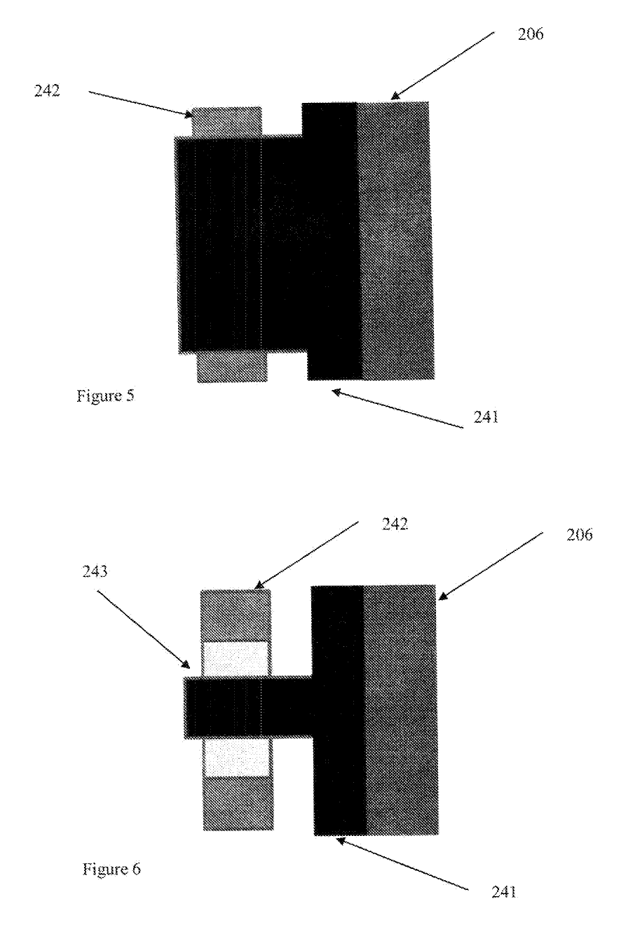

Referring now to FIG. 5 an alternate construction to the device of FIG. 4 is shown. In this case the stationary mount has been replaced with a large bearing. FIG. 6 shows another construction showing a small bearing 243 pressed within a spacing ring.

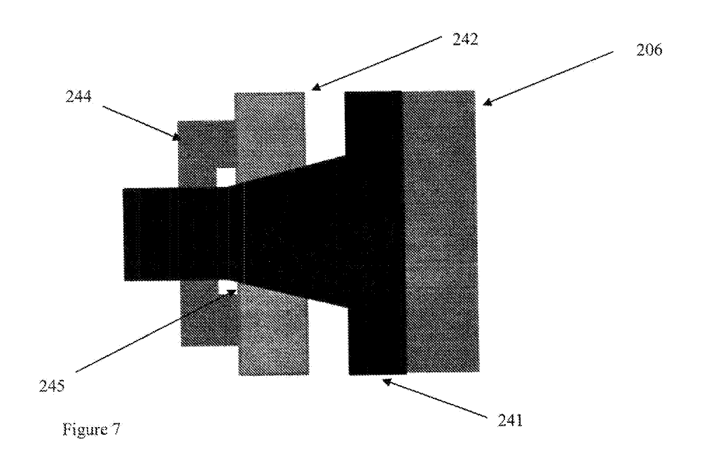

Referring now to FIG. 7 is shown an alternate construction which limits error in spacing caused by clearance between the stationary mount 242 and the gudgeon 241. A preferred low cost construction is to use a non-rolling element bearing for the stationary mount 242. Manufacturing tolerance of the stationary mount and gudgeon require designed in clearance to ensure assemble ability. In addition, dissimilar materials are subject to thermal expansion and for plastic construction. Moisture absorption is a factor, which require additional consideration. The actual running clearance will vary from the design clearance by the part size and by the thermal and moisture absorption factors. The deviation between actual and design clearance from assembly to assembly creates variation in spacing between photoreceptor 206 and image writer 220.

FIG. 7 shows a means to decrease the variation between assemblies. Stationary mount 242 and gudgeon 241 have been modified with mating tapers. Adjustable collar 244 is used to adjust the relative axial position of the stationary mount to minimize clearance between the gudgeon 241 and stationary mount 242. If the same materials are used for gudgeon and stationary mount, thermal and moisture absorption are not a concern. The adjustable collar 244 can be on a screw thread which is tightened and backed off slightly to allow minimal running clearances. If dissimilar materials are used, or compensation to zero running clearance is desired for systems with similar material selection, a spring 245 is used between adjustable collar 244 and stationary mount 242. The addition of a spring 245 allows running at no clearance and also allows axial expansion to compensate for thermal and moisture absorption when dissimilar materials are used.

The invention has been described in detail with particular reference to certain preferred embodiments thereof, but it will be understood that variations and modifications can be effected within the scope of the invention.

### PARTS LIST

31 printing module
111 photoreceptive member
200 replacement cartridge
206 photoreceptor
210 charging subsystem
211 meter
212 meter
213 grid
220 image writer
225 toning unit
226 element
227 element
230 cleaning unit
232a guide
232b guide
233 plastic housing
241 gudgeon
242 stationary mount
243 small bearing
244 adjustable collar
245 spring
248 spacing feature
250 framework

1. An apparatus for mounting a cylindrical photoreceptor comprising:
a gudgeon attached to the photoconductor;
a stationary mount attached to the gudgeon; and
wherein a diameter of the stationary mount matches a diameter of the photoconductor.

2. The apparatus of claim 1 wherein the photoreceptor is comprised of a metal tube covered by a photoconductive surface.

3. The apparatus of claim 2 wherein the photoconductive surface is a sleeve.

4. The apparatus of claim 2 wherein the photoconductive surface is permanently affixed to the surface of the photoreceptor.

5. The apparatus of claim 2 wherein the metal tube, the gudgeon, and the stationary mount are comprised of materials having similar thermal expansion characteristics.

6. The apparatus of claim 1 wherein the gudgeon is attached to the stationary mount with a tapered fit.

7. The apparatus of claim 6 wherein the gudgeon is attached to the stationary mount with an adjustable collar affixed to the shaft of the gudgeon.

8. The apparatus of claim 6 wherein the gudgeon is attached to the stationary mount with a tensioning device.

9. The apparatus of claim 1 wherein the stationary mount is a bearing.

10. The apparatus of claim 1 wherein the stationary mount is a bearing pressed within a metal ring.
